(19) United States
(12) Patent Application Publication
(10) Pub. No.: US 2009/0157365 A1
(43) Pub. Date: Jun. 18, 2009

(54) Simulation device and simulation method

(75) Inventors: Takashi Higuchi, Kobe (JP); Toshio Nakai, Kobe (JP); Takeshi Yamasaki, Kobe (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe (JP)

(21) Appl. No.: 12/314,660

(22) Filed: Dec. 15, 2008

(30) Foreign Application Priority Data
Dec. 18, 2007 (JP) 2007-326538

(51) Int. Cl. G06G 7/48

(52) U.S. Cl. 703/8

(57) ABSTRACT

Provided is a simulation device including: a simple model computing portion for generating simulation information by correcting measured information sampled on a real vehicle on the basis of control information input from an electronic control unit; and an outputting portion for outputting the simulation information generated by the simple model computing portion to the electronic control unit. The simulation device generates the simulation information generated by the simple model computing portion as new measured information.

This application is based on an application No. 2007-326538 filed in Japan, the contents of which are hereby incorporated by reference.

### BACKGROUND OF THE INVENTION

1. Field of the Invention

The present invention relates to a simulation device connected to an electronic control unit targeted for evaluation in order to output thereto simulation information of a vehicle in response to control information output from the electronic control unit. The present invention also relates to a simulation method.

2. Description of the Related Art

In recent years, in various fields, simulation devices are used for the purpose of reducing time and cost required for development of products and the like while at the same time inspecting in advance the safety thereof, or carrying out simulation training of operation of real plants.

The simulation devices include computers for computing models that formulate the mechanisms of real devices and plants and functions that electric signals and the like serve, and are used to, on the basis of computation results, check the properties of the products and the like and solve possible problems in advance, or carry out training.

As such a simulation device, Japanese Unexamined Patent Publication No. 11-326135 proposes a real time simulator that in order to carry out an operation check and a performance estimation of a vehicle engine control device, establishes a virtual environment that simulates a real vehicle to which the engine control device is to be mounted.

The real time simulator includes: a model computer device that carries out a vehicle model program that operates as a virtual vehicle in order to generate simulation signals corresponding to crank angle signals and simulation signals indicating respective steps of the engine and to output the generated simulation signals to the engine control device, thus carrying out the operation check and performance estimation of the engine control device; and a signal generating device that operates in cooperation with the model computer device in order to generate signals required for the vehicle model and output the signals thereto.

A vehicle mounts therein various electronic control units incorporating micro computers in order to control various mechanisms including engine, transmission, and brake. The electronic control units exchange control information through a communication line connected therebetween, thereby carrying out a consistent control operation as a whole.

In order to develop logics for these various electronic control units and examine the developed logics, it is necessary to establish a vehicle model that simulates with fidelity the operation of a real vehicle.

However, for such a vehicle model to be realized, it is necessary to establish highly complicated algorithms and carry out them in a rapid computer, which was difficult to develop.

In view of this, such a simulation device is established that includes a simple model computing portion that samples pieces of control information obtained from the electronic control units mounted in the real vehicle at various situations such as traveling and idling, stores in a memory the pieces of control information as measured information, extracts a piece of measured information necessary for a target electronic control unit as simulation information, and outputs the simulation information to the electronic control unit.

This simulation device enables it to provide the target electronic control unit with virtual environments corresponding to various operation states of the vehicle.

However, the simulation device that simulates the vehicle with the simple model computing portion outputs, from pieces of control information sampled in advance, pieces of information necessary for the electronic control unit in a time sequential manner. Thus, this simulation device merely enables it to check passive operation states in the sequence of the electronic control unit in accordance with the measured information.

For dynamic operation checks attending to the various vehicle states to be carried out, it is necessary to sample in advance a multiplicity of pieces of measured information corresponding to the various vehicle states, which posed the problem of substantial work for the sampling processing of the measured information.

When the electronic control unit needs to carry out predetermined feedback control, learning control, and the like with respect to a control target in accordance with the measured information, the measured information output from the simulation device does not reflect the feedback control and the like, which posed the problem of failure to effectively check the control logic of an electronic control unit under development.

### SUMMARY OF THE INVENTION

In view of the foregoing problems, an object of the present invention is to provide a simulation device capable of carrying out a dynamic simulation by providing an electronic control unit with virtual environments corresponding to various vehicle operation states, even though the simulation device includes a simple model computing portion that outputs simulation information necessary for the electronic control unit on the basis of control information measured on a real vehicle.

In order to accomplish the above object, the simulation device according to the present invention is connected to an electronic control unit targeted for evaluation in order to output thereto simulation information of a real vehicle in response to control information output from the electronic control unit. The simulation device is characterized in including: a measured information storing portion for storing measured information obtained from an actual travel of the real vehicle; a simple model computing portion for generating simulation information by correcting the measured information on the basis of control information output from the electronic control unit; and an outputting portion for outputting the simulation information generated by the simple model computing portion to the electronic control unit.

The present invention will become more apparent in the detailed description of the preferred embodiments presented below.

### BRIEF DESCRIPTION OF THE DRAWINGS

FIG. 1 is a configuration block diagram of a simulation device according to an embodiment of the present invention;

FIG. 2 is a circuit block diagram of the simulation device;

FIG. 3 is a diagram for illustrating collection of data from ECU and a navigation device;

FIG. 4A is a diagram for illustrating vehicle model information, and FIG. 4B is a diagram for illustrating vehicle model information to which noise signal levels are added;

FIG. 5 is a flowchart for describing the operations of the simulation device and ACC-ECU;

FIG. 6 is a flowchart for describing generation of simulation information;

FIG. 7 is a diagram for illustrating measured information related to relative distance information with respect to a preceding vehicle and vehicle speed information in the case of carrying out automatic following travel control;

FIG. 8 is a diagram for illustrating a positional relation between the vehicle of interest and the preceding vehicle in the case of carrying out the automatic following travel control;

FIG. 9 is a flowchart for describing the operations of the simulation device and ACC-ECU in another embodiment;

FIG. 10 is a configuration block diagram for illustrating an algorithm for correction processing of measured information carried out by a simple model computing portion;

FIG. 11 is a configuration block diagram for illustrating an algorithm for correction processing of measured information of a vehicle carried out by the simple model computing portion; and

FIG. 12 is a configuration block diagram for illustrating another algorithm for correction processing of measured information carried out by a simple model computing portion.

### DESCRIPTION OF THE PREFERRED EMBODIMENTS

A vehicle simulation device to which a simulation device according to the present invention is applied will be described below.

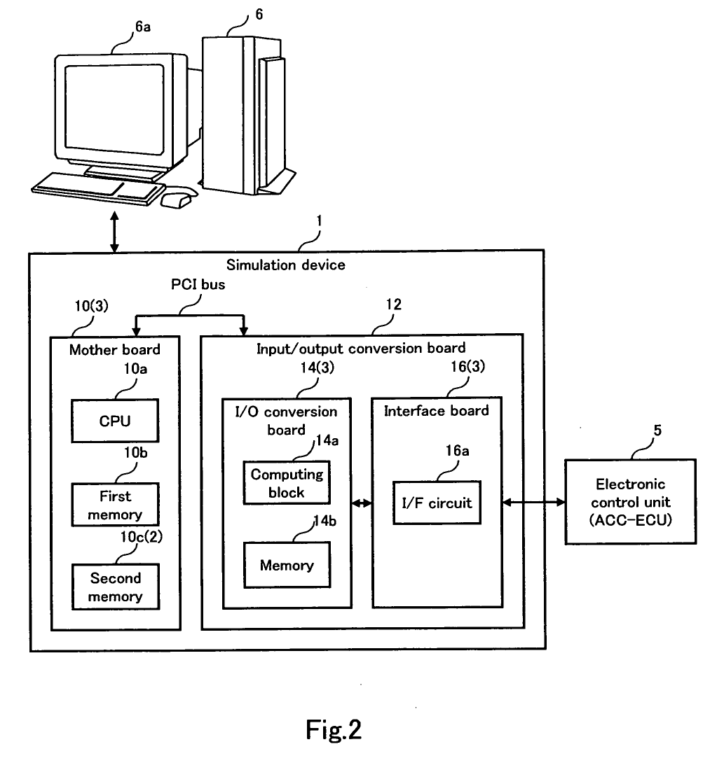

Referring to FIG. 2, a vehicle simulation device 1 is connected to an electronic control unit 5 (hereinafter occasionally referred to as “ECU (Electronic Control Unit)”) targeted for evaluation in order to output thereto simulation information of a vehicle in response to control information output from the electronic control unit 5.

The vehicle simulation device 1 includes a measured information storing portion 2 for storing measured information collected from a vehicle during an actual travel thereof, a simple model computing portion 3 for generating simulation information by correcting the measured information on the basis of control information output from the electronic control unit 5, and an outputting portion for outputting the simulation information generated by the simple model computing portion 3 to the electronic control unit 5.

The vehicle simulation device 1 includes a mother board 10 mounting thereon a CPU that carries out applications under administration of an operating system (hereinafter referred to as “OS”), and a plurality of input/output conversion boards 12 each connected to the mother board 10 through a PCI bus. The mother board 10 and the input/output conversion boards 12 are housed in a casing.

The mother board 10 includes a CPU 10a, a first memory 10b that stores the OS and applications such as a vehicle model program, a second memory 10c serving as the measured information storing portion 2 to store the measured information, the simulation information, and the like, a LAN interface connected to a host computer 6, peripheral circuits, and the like.

The input/output conversion boards 12 each include a single or a plurality of I/O conversion boards 14 and a single or a plurality of interface boards 16.

The I/O conversion board 14 includes a computing block 14a having CPU, FPGA or ASIC, and the like, and a memory 14b that stores results of calculations by the computing block 14a.

The I/O conversion board 14 converts logical simulation information calculated by the mother board 10 into a physical simulation signal corresponding to the electronic control unit 5, and converts a physical control signal output from the electronic control unit 5 into logical control information.

The interface board 16 includes an interface circuit 16a that intermediates for a power line and a signal line that connect the I/O conversion board 14 and the electronic control unit 5.

The interface circuit 16a is a circuit block that carries out electrical matching for the voltage of the power line and the signal on the signal line, that is, changes the voltage and the signal to levels corresponding to the I/O conversion board 14 and the electronic control unit 5, or changes the signal form.

The host computer 6 is connected to the vehicle simulation device 1 through the LAN interface and assumes general control of the device, including the simple model computing portion 3.

The host computer 6 carries out and discontinues a simulation and sets conditions therefor after loading the measured information in the second memory 10c of the mother board 10, and at the same time collects the control information output from the electronic control unit 5 and the simulation information processed by the simple model computing portion 3, and then displays the information on a monitor 6a.

An operator visually checks the control information and the like displayed on the monitor 6a of the host computer 6 and evaluates the suitability of the control logic.

The vehicle model program, the mother board 10 including the CPU that carries out the vehicle model program, and the I/O conversion board 14 constitute the simple model computing portion 3 according to the present invention, and the interface board 16 constitutes the outputting portion according to the present invention.

The simple model computing portion 3 repeats a computation of a predetermined period shorter than the period of computation control carried out by the electronic control unit 5, and the outputting portion outputs thereto simulation information generated during each computation period.

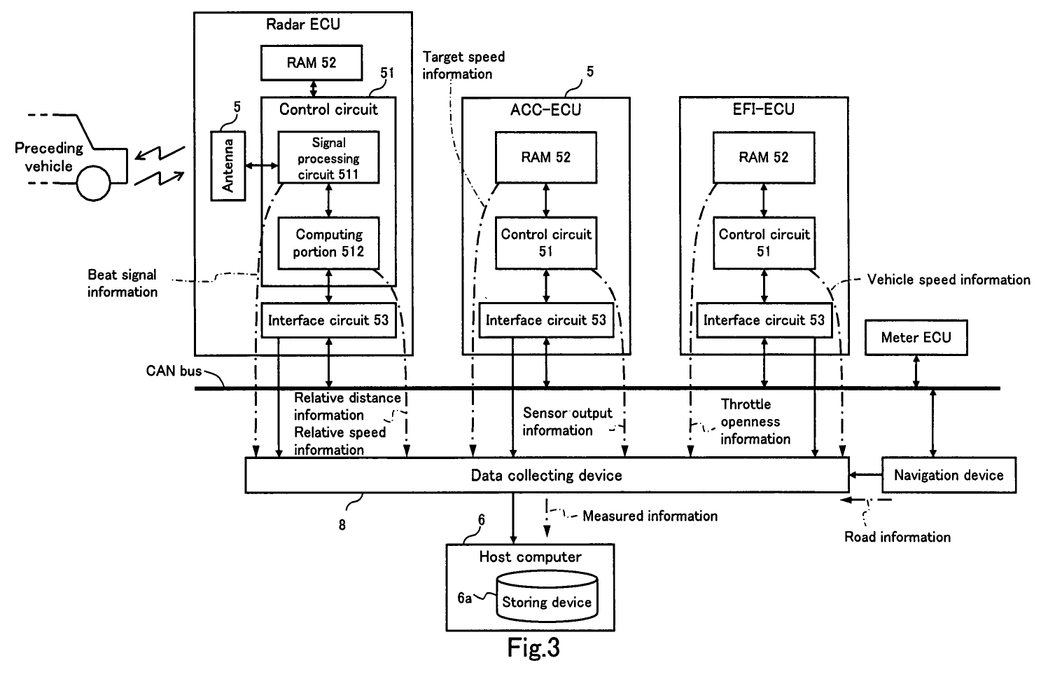

Referring to FIG. 3, a real vehicle mounts therein an EFI-ECU for controlling the engine, an ACC-ECU for carrying out adaptive cruise control, a radar ECU of the FMCW system for detecting a preceding vehicle, a meter ECU for displaying the vehicle speed, engine speed, and the like, and a plurality of ECUs including a navigating device. The ECUs are connected to each other through a vehicle-mounted LAN such as CAN (Controller Area Network).

In order to adjust the speed of the vehicle of interest to a predetermined speed while adjusting the distance to the preceding vehicle, the ACC-ECU outputs a speed control instruction to the EFI-ECU on the basis of vehicle speed information input from the EFI-ECU, road information input from the navigating device, relative speed information and relative distance information with respect to the preceding vehicle input from the radar ECU, and the like.

In adjusting the speed of the vehicle to a predetermined speed, there is also a case where instead of outputting the speed control instruction to the EFI-ECU, the ACC-ECU outputs a control signal for controlling the degree of openness of the electronic throttle.

Each of the ECUs incorporates a control circuit 51 provided with a micro computer, a RAM 52 for data storage, an interface circuit 53 including a CAN interface, and the like.

For example, the radar ECU incorporates a signal processing circuit 511 for detecting a beat signal from a signal received from an antenna 50, and a control circuit 51 provided with a computing portion 512 that calculates the relative speed and relative distance with respect to the preceding vehicle on the basis of the beat signal.

This vehicle mounts therein a data collecting device 8 connected to the ECUs through respective interface circuits 53, so that the data collecting device 8 collects output information from the control circuits 51 provided in the ECUs, control information stored in the RAMs 52 provided in the ECUs, and control information transmitted through the CAN. The control information includes control signals that the ECUs output to control targets, and vehicle signals that control targets input to the ECUs.

The data collecting device 8 is of a hardware configuration similar to that of the vehicle simulation device 1, and the mother board installs a model program for sampling necessary control information from the ECUs at predetermined time intervals.

The data collecting device 8 is connected to the host computer 6 through the LAN interface. The time interval for the sampling preferably agrees to the computation period of the simple model computing portion 3.

The data collecting device 8 samples, at predetermined time intervals, control information processed or generated by the ECUs at various situations such as traveling and idling of the real vehicle, and transmits the sampling data to the host computer 6 through the LAN interface. The host computer 6 stores the received sampling data as measured information in a storing device 6b such as the hard disc.

That is, the control information collected from the ECUs including the ACC-ECU and stored in the storing device 6b while the vehicle is actually traveling serves as the measured information that is loaded from the host computer 6 to the vehicle simulation device 1.

For example, the data collecting device 8 collects beat signal information output from the signal processing circuit 511 of the radar ECU, and relative distance information and relative speed information output from the computing portion 512.

The data collecting device 8 collects target vehicle speed information stored in the RAM 52 of the ACC-ECU and output information of various sensors output from the control circuit 51.

The data collecting device 8 collects throttle openness information stored in the RAM 52 of the EFI-ECU and vehicle speed information output from the control circuit 51.

Further, the data collecting device 8 collects road profile information output from the navigating device provided with a map database, that is, state information of a road on which the real vehicle travels including slope information, curve information, and the like of the road.

This road profile information includes slope information and curve information of the road read from the map database on the basis of travel location information of the vehicle calculated from a GPS signal by the navigating device.

The slope information and the curve information of the road may also be obtained from the posture of the vehicle calculated by the ACC-ECU on the basis of output information of a yaw rate sensor, a steering angle sensor, and the like input to the ACC-ECU.

That is, the measured information includes vehicle speed information and throttle openness information obtained from the EFI-ECU, beat signal information obtained from the radar ECU, relative distance information and relative speed information with respect to the preceding vehicle calculated by the radar ECU on the basis of a beat signal, road information of a road on which the real vehicle actually travels and which is obtained from the navigating device, and information of a yaw rate sensor, a steering angle sensor, an acceleration sensor, and a wheel speed sensor.

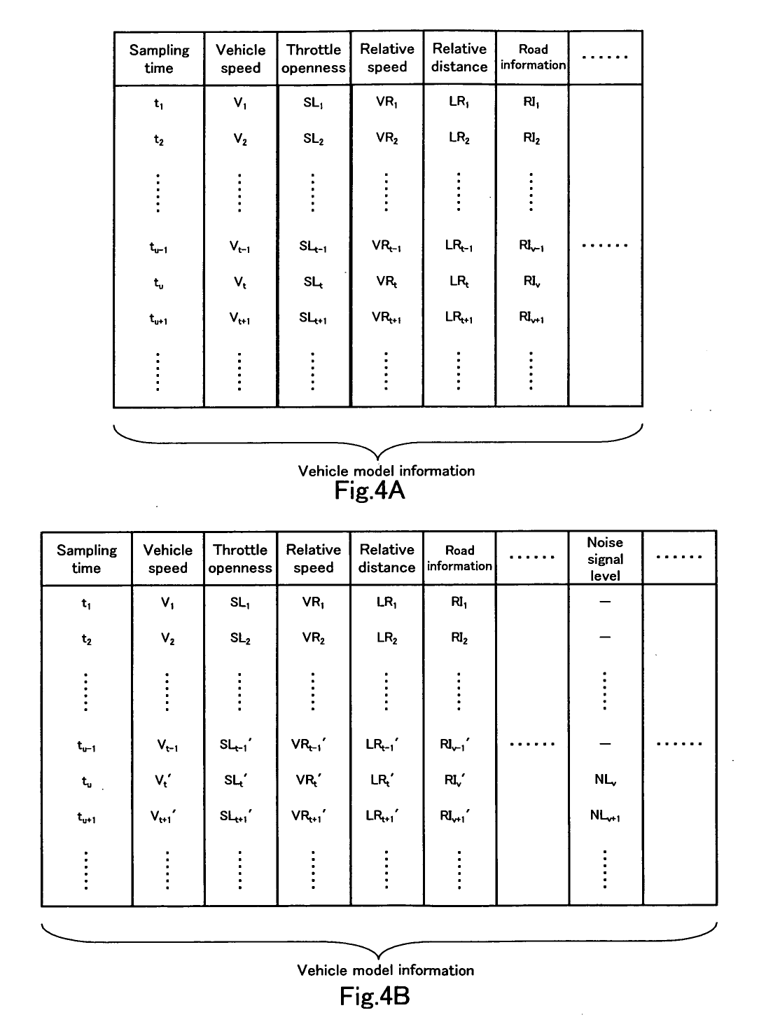

Referring to FIG. 4A, a plurality of pieces of control information including the vehicle speed information, throttle openness information, relative speed information and relative distance information with respect to the preceding vehicle, road profile information, and travel location information of the vehicle of interest are associated with each other at a sampling time of each data, thereby generating vehicle model information that changes in accordance with the traveling state of the real vehicle.

The vehicle model information is not limited to the configuration that associates the plurality of pieces of measured information with each other at sampling times. For example, such a configuration is possible that associates the plurality of pieces of measured information with location information of the road on which the real vehicle travels.

As an example, the vehicle simulation device 1 in the case where the simulation target is a program for adaptive cruise control will be described in detail below.

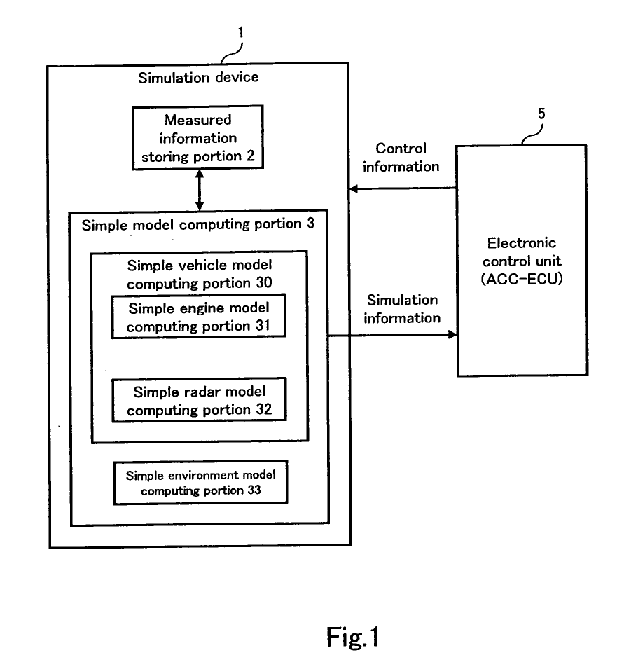

Referring to FIG. 1, to the vehicle simulation device 1, the ACC-ECU, which is the electronic control unit 5 for carrying out the adaptive cruise control, is connected.

It is when the control logic of an existing ACC-ECU is improved or when the control logic of a new ACC-ECU is developed that the vehicle simulation device 1 according to the present invention is connected to the target ACC-ECU.

In the first memory 10b (see FIG. 2) of the vehicle simulation device 1, a vehicle model program is loaded from the host computer 6. Carrying out the vehicle model program at the CPU 10a realizes a simple model computing portion 3 including a simple vehicle model computing portion 30 provided with functions including a simple engine model computing portion 31 and a simple radar model computing portion 32.

In the present embodiment, the simple model computing portion 3 further includes a simple environment model computing portion 33. The simple environment model computing portion 33 generates simulation information that simulates environment state information of the road on which the vehicle is traveling, information about another vehicle preceding the vehicle, and even information about pedestrians.

In the second memory 10c of the vehicle simulation device 1, the measured information shown in FIG. 4A, that is, vehicle model information is loaded from the host computer 6.

The simple model computing portion 3 selects necessary information from the vehicle model information on the basis of the control information input from the ACC-ECU, and outputs the information thereto as simulation information that models the traveling state of the vehicle.

For example, the simple model computing portion 3 in the case of computing for a control period t selects, as simulation information, necessary information such as vehicle speed and relative speed corresponding to the sampling time t of the vehicle model information shown in FIG. 4A, and outputs the information to the ACC-ECU in a time sequential manner. That is, the simple model computing portion 3 carries out the computation with its computation period in synchronism with the sampling period of the measured information.

When the computation period of the simple model computing portion 3 differs from the sampling period of the measured information, it is possible to calculate, as the measured information, a value that agrees to the computation period of the simple model computing portion 3 by making an interpolation to existing measured information.

The simple engine model computing portion 31 outputs simulation information related to the vehicle speed and throttle openness, the simple radar model computing portion 32 outputs simulation information related to the relative distance and relative speed with respect to the preceding vehicle, and the simple environment model computing portion 33 outputs simulation information related to the environment of the road.

The ACC-ECU carries out a predetermined computation on the basis of these pieces of simulation information and outputs the resulting control information to the vehicle simulation device 1.

This enables an estimation as to the suitability of the sequential control logic of the ACC-ECU on the basis of the control information output from the ACC-ECU corresponding to the simulation information output from the simple model computing portion 3.

However, the simulation signal output from the simple model computing portion 3 corresponding to the control information output from the ACC-ECU is limited to information sampled in advance, which makes difficult a dynamic control logic estimation as to, for example, the suitability of feedback control carried out by the ACC-ECU.

In order to address this problem, it is necessary to sample in advance a multiplicity of pieces of measured information corresponding to various traveling states, select a suitable piece of information from the multiplicity of pieces of measured information corresponding to the control information output from the ACC-ECU, and output the information as simulation information. However, this has the drawback of involving enormous preparatory sampling work.

In view of this, in the vehicle simulation device 1 according to the present invention, the simple model computing portion 3 is configured to output simulation information resulting from correcting the measured information on the basis of the control information input from the ACC-ECU.

Examples of the correction include: decreasing the level of the signal received by the radar device by taking into consideration the wave multiplication phenomenon of decreasing the reflected wave of the radar device when the distance to the preceding vehicle decreases; and increasing or decreasing the speed on the basis of an accelerating operation signal.

The measured information is output after some parts of the information shown in FIG. 4A are corrected as shown in FIG. 4B, where the corrected pieces of data are denoted with (′). By storing such corrected simulation information as new measured information in the memory, the measured information can be increased.

The measured information corrected in a simulation and stored in the memory is configured to be directly usable in another simulation, without being corrected.

The selection as to whether to carry out a static simulation or a dynamic simulation is set through the host computer 6.

The static simulation refers to a mode in which measured information sampled in advance or measured information corrected in a prior simulation is output as simulation information without correction, and the dynamic simulation refers to a mode in which measured information corrected on the basis of measured information sampled in advance or on the basis of measured information corrected in a prior simulation is output as simulation information.

The vehicle simulation device 1 according to the present invention is also configured to, in the course of simulation, add data items that did not originally exist in the measured information, as shown in FIG. 4B.

This function can be realized by, for example, providing a model program for generating a new kind of measured data from existing measured data. Examples include generating acceleration information by differentiating the vehicle speed information.

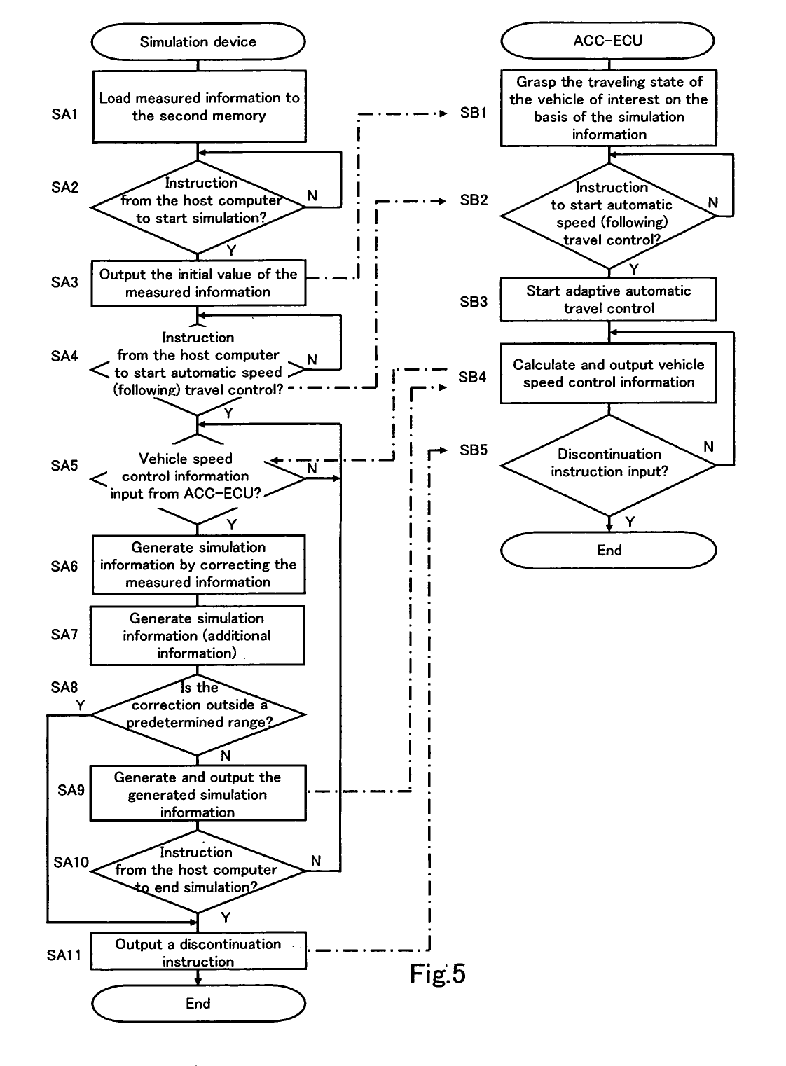

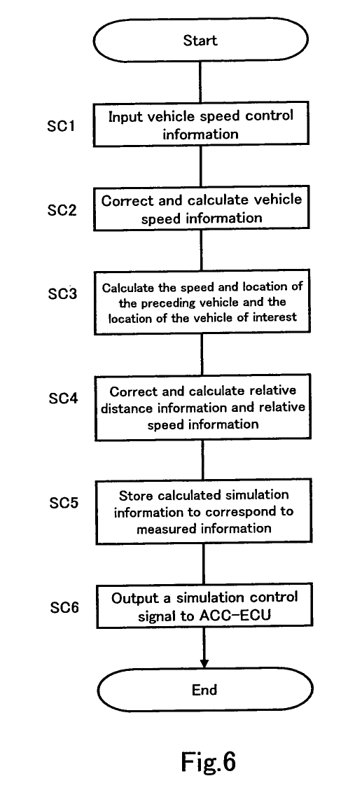

Operation of the vehicle simulation device to which the ACC-ECU is connected will be described below by referring to the flowcharts shown in FIGS. 5 and 6.

When measured information stored in the hard disc 6b of the host computer 6 is loaded into the second memory 10c of the mother board 10 (SA1), and a simulation starts on the basis of an instruction from the host computer 6 (SA2), then the simple model computing portion 3 outputs to the ACC-ECU simulation information including initial values of the vehicle speed information, the throttle openness information, and the road information, which are included in the measured information read from the second memory 10c (SA3).

The ACC-ECU to which the simulation information is input operates in accordance with a control logic in order to grasp the traveling state of the vehicle of interest on the basis of the vehicle speed information, the throttle openness information, the vehicle distance information with respect to the preceding vehicle, and the like included in the simulation information (SB1).

When the host computer 6 outputs an automatic speed travel control starting instruction (SA4), the automatic speed travel control starting instruction is input to the ACC-ECU through the interface board 16 of the vehicle simulation device 1 (SB2).

The automatic speed travel control starting instruction is a signal corresponding to an automatic speed travel signal output to the ACC-ECU by operating an adaptive cruise control switch provided in the vicinity of the steering of the real vehicle.

The ACC-ECU starts adaptive automatic travel control corresponding to target vehicle speed information (SB3). The target vehicle speed information refers to simulation vehicle speed information at the time of input of the automatic speed travel control starting instruction.

The ACC-ECU carries out feedback computation of vehicle speed control information on the basis of deviation between the simulation vehicle speed information, which is output from the simple model computing portion 3, and the target vehicle speed information.

When the vehicle distance is sufficiently larger than a predetermined vehicle distance, the ACC-ECU outputs the feedback-computed vehicle speed control information to the vehicle simulation device 1 (SB4).

When the distance to the preceding vehicle is smaller than a predetermined vehicle distance, the ACC-ECU outputs to the vehicle simulation device 1 vehicle speed control information resulting from correcting the feedback-computed vehicle speed control information on the basis of the simulation vehicle distance information.

That is, the ACC-ECU controls the vehicle speed to keep it at a predetermined speed while securing some distance to the preceding vehicle. When the vehicle distance is small, the ACC-ECU outputs to the vehicle simulation device 1 vehicle speed control information corrected at least to secure a predetermined vehicle distance (SB4).

When the host computer 6 outputs an automatic following travel control starting instruction (SA4), the automatic following travel control starting instruction is input to the ACC-ECU through the interface board 16 of the vehicle simulation device 1 (SB2).

The automatic following travel control starting instruction is a signal corresponding to an automatic following travel signal output from the ACC-ECU by operating an adaptive cruise control switch provided in the vicinity of the steering of the real vehicle.

The ACC-ECU starts adaptive automatic travel control corresponding to target vehicle distance information (SB3).

The ACC-ECU controls the vehicle speed to secure the vehicle distance information with respect to the preceding vehicle within a predetermined range that is set around the target vehicle distance information, which is set in order to secure safety. The target vehicle distance information refers to simulation vehicle distance information at the time of input of the automatic following travel control starting instruction.

The ACC-ECU outputs to the vehicle simulation device 1 the vehicle speed control information that results from feedback computation in accordance with deviation between the simulation vehicle distance information, which is output from the simple model computing portion 3, and target vehicle distance information corresponding to the simulation vehicle distance information (SB4).

That is, the ACC-ECU controls to increase the vehicle speed when the simulation vehicle distance information is larger than the target vehicle distance information or to decrease the vehicle speed when the simulation vehicle distance information is smaller than the target vehicle distance information.

When the ACC-ECU carries out the automatic speed travel control and the automatic following travel control and outputs the vehicle speed control information to the vehicle simulation device 1 (SB4), the simple model computing portion 3 generates simulation vehicle speed information and the like next to output by correcting measured information on the basis of the vehicle speed control information (SA5, SA6).

As necessary, the simple model computing portion 3 generates a new data item on the basis of corrected vehicle speed control information and the like and adds the new data item to the measured information (SA7).

For example, when the ACC-ECU incorporates a control logic to deal with rapid acceleration or rapid deceleration, the simple model computing portion 3 adds simulation acceleration information calculated from the simulation vehicle speed information.

The simple model computing portion 3 judges whether the difference between the corrected simulation information and the original measured information is within a predetermined range (SA8). When the difference is within the predetermined range, the simple model computing portion 3 continues the simulation. That is, the simple model computing portion 3 outputs the simulation information generated in steps SA6 and SA7 to the ACC-ECU (SA9). When the difference is outside the predetermined range, the simple model computing portion 3 outputs a discontinuation instruction to the ACC-ECU (SA11) and ends the simulation. The predetermined range refers to a range conveniently set on the basis of the accuracy of simulation and the like.

The predetermined range is because the difference between the original measured information and the corrected simulation information might increase if the simple model computing portion 3 repeats the series of processing associated with outputting the simulation information resulting from correcting the measured information to the ACC-ECU, thereby undermining the reliability of the simulation information.

The predetermined range is also for the purpose of preventing inconveniences including failure to carry out the automatic following travel control by the simple model computing portion 3 because of the negativity of the value of the corrected simulation vehicle distance information or exceeding of the simulation vehicle distance information over a predetermined value, which indicates that there are no preceding vehicles.

The ACC-ECU repeats the operations of steps SB1 to SB4 until the host computer 6 outputs an end instruction (SA10) and the vehicle simulation device 1 outputs a discontinuation instruction (SA11).

The correction processing carried out in step SA6 when the ACC-ECU carries out the automatic following travel control will be described in detail below.

The simple engine model computing portion 31 includes multidimensional map data that sets speed conversion functions for combinations of simulation vehicle speed information, deviation between the simulation vehicle speed information and vehicle speed control information, and road state information including slope information and curve information of the road.

Referring to FIG. 6, when the ACC-ECU inputs the vehicle speed control information (SC1), the simple engine model computing portion 31 adjusts simulation vehicle speed information next to output on the basis of the vehicle speed control information input from the ACC-ECU.

This will be described in detail. The simple engine model computing portion 31 generates, as corrected simulation vehicle speed information next to output to the ACC-ECU, the product of former simulation vehicle speed information read from the measured information or simulation vehicle speed information resulting from former correction of the measured information, a speed conversion function read from the multidimensional map data, and a predetermined time (SC2).

The predetermined time is preferably set at the period for which the simulation vehicle speed information is output to the ACC-ECU or at the computation period of the ACC-ECU.

The simple radar model computing portion 32 calculates the speed and location of the preceding vehicle and the location of the vehicle of interest on the basis of the formerly output simulation information (SC3), and corrects new simulation relative speed information and simulation relative distance information next to output to the ACC-ECU on the basis of the corrected simulation vehicle speed information calculated by the simple engine model computing portion 31 and the speed and location of the preceding vehicle (SC4).

The simple model computing portion 3 stores, as new measured information, the simulation information including the simulation vehicle speed information, the simulation relative speed information, and the simulation relative distance information corrected on the basis of existing measured information, and control information output from the ACC-ECU on this occasion in the memory 14b (SC5), and outputs simulation control signals of the corrected simulation vehicle speed information and the like to the ACC-ECU (SC6).

The ACC-ECU carries out automatic following travel control similar to the forgoing on the basis of the simulation vehicle speed information, simulation relative speed information, and simulation relative distance information output from the simple model computing portion 3, and as a result of this, outputs new vehicle speed control information to the vehicle simulation device 1 (SB4).

The simple engine model computing portion 31 calculates, upon input of the new vehicle speed control information, simulation vehicle speed information next to output in a similar manner to the foregoing.

Likewise, the simple radar model computing portion 32 calculates simulation relative speed information and simulation relative distance information next to output on the basis of the next simulation vehicle speed information corrected by the simple engine model computing portion 31.

The simple model computing portion 3 outputs the corrected simulation vehicle speed information, simulation relative speed information, and simulation relative distance information to the ACC-ECU and stores in the memory 14b new measured information including these simulation information and road state information.

The vehicle simulation device 1 repeats the above operation until the host computer 6 outputs a discontinuation instruction, and ends the simulation upon output of the discontinuation instruction (SA7).

The new measured information stored in the memory 14b is then transmitted to the host computer 6 and stored in the memory thereof to be used in the next simulation.

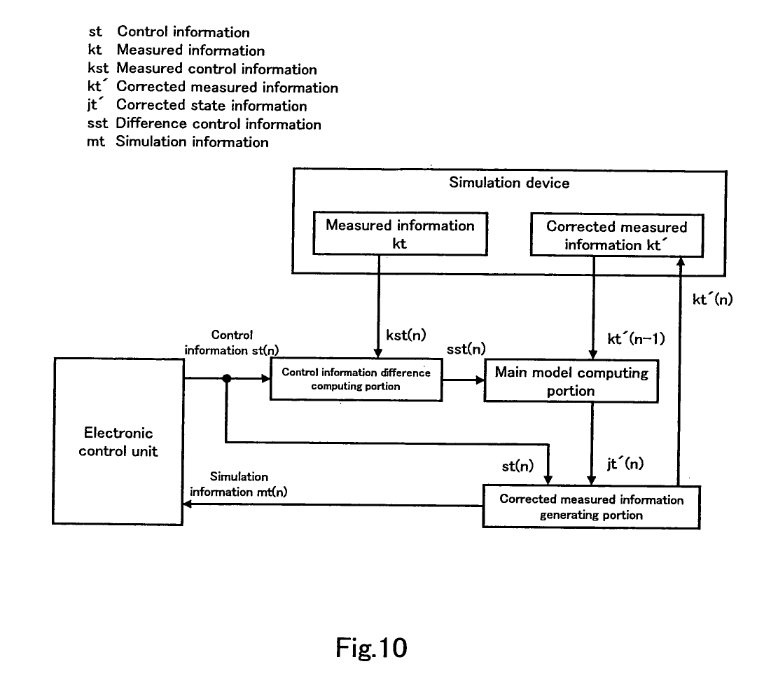

FIG. 10 shows another example of representative correction algorithm for measured information.

The simple model computing portion is composed of functional blocks including a control information difference computing portion, a main model computing portion, and a corrected measured information generating portion.

The control information difference computing portion reads, upon input of control information st(n) from the electronic control unit, measured control information kst(n) that is measured information stored in the storing portion and corresponds to the control information st(n), calculates difference control information sst(n) of the control information st(n) and the measured control information kst(n), and outputs the difference control information sst(n) to the main model computing portion.

The main model computing portion reads corrected measured information kt′(n−1) formerly corrected by the corrected measured information generating portion and stored in the storing portion, and generates, from a predetermined model computation formula, corrected state information jt′(n) that indicates a vehicle state predicted to change corresponding to control information currently input from the electronic control unit on the basis of the difference control information sst(n) and the corrected measured information kt′(n−1). It is noted that “n” is a natural number indicating the number of times of computation. When n=1, measured information kt(1) is employed as the initial value for the corrected measured information kt′(n−1).

As the corrected measured information kt′(n−1) input to the main model computing portion, it is particularly preferable to employ a former value st(n−1) of this control information or a former value jt′(n−1) of this corrected state information.

The predetermined model computation formula from which the main model computing portion generates the corrected state information jt′(n) is a computation formula for obtaining the amount of change in the corrected measured information kt′(n−1) in accordance with the difference control information sst(n), and is predetermined on a control information kind basis.

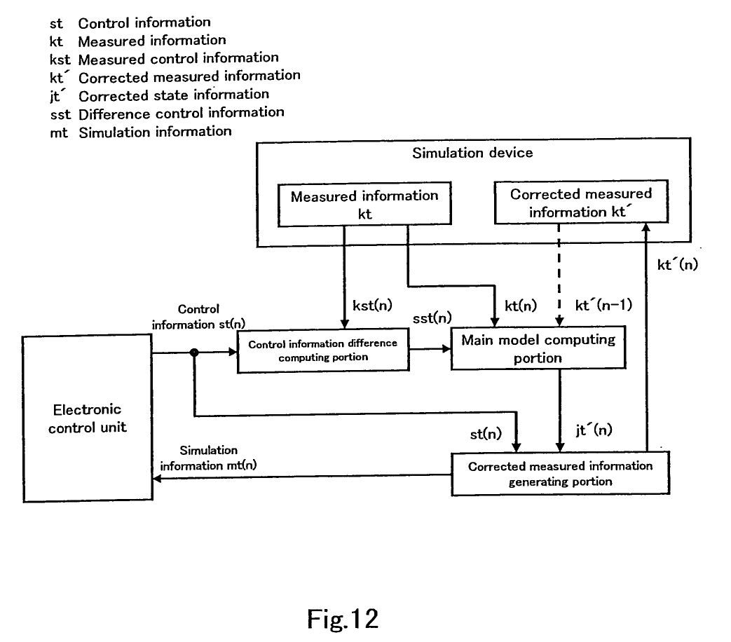

The main model computing portion may also be configured to read the measured information kt(n) stored in the storing portion instead of reading the corrected measured information kt′(n−1) stored in the storing portion, and generate, from a predetermined model computation formula, corrected state information jt′(n) that indicates a vehicle state predicted to change corresponding to control information currently input from the electronic control unit on the basis of the difference control information sst(n) and the measured information kt(n). FIG. 12 shows a configuration block diagram illustrating an algorithm corresponding to this configuration.

Further, the main model computing portion may also be configured to read the corrected measured information kt′(n−1) stored in the storing portion in addition to the measured information kt(n), and generate, from a predetermined model computation formula, corrected state information jt′(n) that indicates a vehicle state predicted to change corresponding to control information currently input from the electronic control unit on the basis of the difference control information sst(n), the measured information kt(n), and the corrected measured information kt′(n−1), as represented by the broken line in FIG. 12.

In this case, the predetermined model computation formula from which the main model computing portion generates the corrected state information jt′(n) is a computation formula for obtaining the amount of change in the measured information kt(n) in accordance with the difference control information sst(n), or a computation formula for obtaining the amount of change in the corrected measured information kt′(n−1) in accordance with the difference control information sst(n) and the measured information kt(n).

Generally, the model computing portion is configured to compute and output an output parameter Ct(n) with respect to input parameters At(n) and Bt(n) on the basis of a complicated physical model that simulates a behavior of the control target with a formula. At(n), Bt(n), and Ct(n) are mutually different physical quantities.

In the present invention, however, the simple model computing portion is configured to obtain a difference in input parameter At on the basis of formerly measured input parameter At(n−1) and output parameter Ct(n−1) and on the basis of a newly input input parameter At(n), and to output a new output parameter Ct(n) resulting from correcting the former output parameter Ct(n−1) corresponding to the difference.

Thus, the present invention has the advantage of eliminating the need for establishing a complicated physical model and porting it to the model computing portion; it is only necessary to port a significantly simple formula to the model computing portion.

The corrected state information jt′(n) generated by the main model computing portion is output to the corrected measured information generating portion.

The corrected measured information generating portion outputs the corrected state information jt′(n) as simulation information mt(n) corresponding to the control information st(n) to the electronic control unit. The simulation information mt(n) generated on this occasion is stored in the storing portion as new measured information.

That is, the simple model computing portion is configured to calculate a difference between the control information output from the electronic control unit and measured control information included in the measured information and corresponding to the control information, and generate simulation information by correcting the measured information on the basis of the difference.

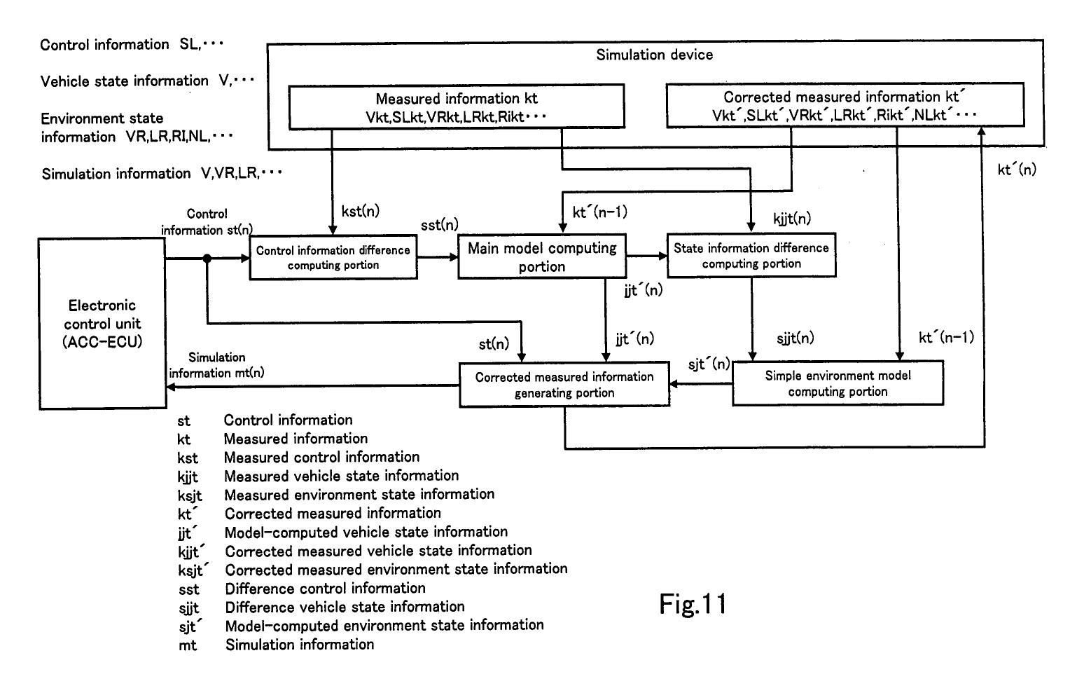

FIG. 11 shows another specific example of correction algorithm in the case where the electronic control unit is the ACC-ECU. In this example, the state of the vehicle of interest and the environment state of the vehicle of interest are corrected with the use of the measured information, and the ACC-ECU outputs throttle openness and the like as control information.

The simple model computing portion is composed of functional blocks including a control information difference computing portion, a main model computing portion, a state information difference computing portion, an environment model computing portion and a corrected measured information generating portion.

Measured information kt shown in FIG. 11 includes vehicle speed Vk, throttle openness SLk, relative speed VRk, relative distance Lrk, and road profile information RIk, as shown in FIG. 4.

The control information difference computing portion reads, upon input of control information st(n) such as throttle openness from the ACC-ECU, measured control information kst(n) that is measured information stored in the storing portion and corresponds to the throttle openness, calculates difference control information sst(n) of the control information st(n) and the measured control information kst(n), and outputs the difference control information sst(n) to the main model computing portion.

The main model computing portion reads corrected measured information kt′(n−1) formerly corrected by the corrected measured information generating portion and stored in the storing portion, and generates model-computed vehicle state information jjt′(n) that indicates a vehicle state predicted to change corresponding to control information currently input from the ACC-ECU on the basis of the difference control information sst(n) and the corrected measured information kt′(n−1).

It is noted that “n” is a natural number indicating the number of times of computation. When n=1, measured information kt(1) is employed as the initial value for the corrected measured information kt′(n−1).

The corrected measured information kt′(n−1) refers to measured information that is influenced by the fluctuation of the throttle openness and includes vehicle speed Vk′(n−1). A predetermined model computation formula from which the state information computing portion generates the model-computed vehicle state information jjt′ is predetermined on a control information kind basis.

The model-computed vehicle state information jjt′(n) generated by the main model computing portion and corresponding to the vehicle speed Vk′(n−1) and the like is output to the state information difference computing portion and the corrected measured information generating portion.

The state information difference computing portion reads measured vehicle state information kjjt(n) that is measured information stored in the storing portion and indicates the state of the vehicle of interest such as vehicle speed Vk(n), and calculates difference vehicle state information sjjt(n) from The model-computed vehicle state information jjt′(n) and the measured vehicle state information kjjt(n). For example, difference information of vehicle speed and the like is calculated as difference vehicle state information sjjt(n).

The difference vehicle state information sjjt(n) calculated by the state information difference computing portion is output to the simple environment model computing portion.

The simple environment model computing portion reads the corrected measured information kt′(n−1) from the storing portion, and calculates model-computed environment state information sjt′(n) from the difference vehicle state information sjjt(n) and the corrected measured information kt′(n−1).

That is, a correction is made to measured information indicating an environment state such as the relative speed with respect to the preceding vehicle, which changes in accordance with a change in state of the vehicle of interest, and the road profile. A model computation formula for the correction is predetermined on a measured information kind basis. For example, the corrected relative speed can be calculated by adding or subtracting the vehicle speed difference information of the vehicle of interest to or from the relative speed.

The model-computed environment state information sjt′(n) calculated by the simple environment model computing portion is output to the corrected measured information generating portion.

Corresponding to the control information st(n), the corrected measured information generating portion outputs, as simulation information mt(n), the model-computed vehicle state information jjt′(n) and the model-computed environment state information sjt′(n) to the ACC-ECU. The simulation information mt(n) generated on this occasion is stored in the storing portion as new measured information.

That is, the simple model computing portion is configured to calculate a difference between the control information output from the electronic control unit and measured control information included in the measured information and corresponding to the control information and correct the vehicle state information on the basis of the difference, and then calculate a difference between the corrected vehicle state information and measured vehicle state information included in the measured information and corresponding to the vehicle state information and correct the environment state information on the basis of the difference, thus rendering the corrected vehicle state information and the corrected environment state information the simulation information.

While the above description is about the configuration where the simple model computing portion 3 corrects the measured information on the basis of the vehicle speed control information output from the ACC-ECU, it will be readily appreciated that the measured data targeted for correction and the correction computation vary depending on the ECU connected to the vehicle simulation device 1.

With the simulation device according to the present invention, repeating the above computation processing provides the electronic control unit with various virtual environments corresponding to various vehicle operation states, thereby realizing a dynamic simulation.

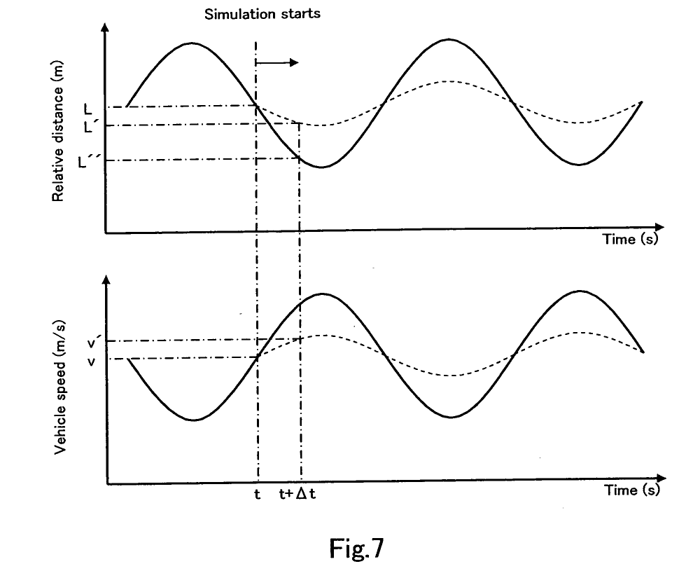

The properties represented by the solid lines shown in FIG. 7 are those of the relative distance with respect to the preceding vehicle and the vehicle speed information measured when automatic following travel control is carried out by an existing ACC-ECU incorporated in a real vehicle.

In view of a large vehicle-distance hunting property resulting from the control logic incorporated in this ACC-ECU, description will be made of an example where a control logic improved to lessen the hunting property is incorporated in the ACC-ECU and a dynamic simulation is carried out by the vehicle simulation device 1 according to the present invention.

The ACC-ECU calculates vehicle speed control information on the basis of simulation relative distance information L, simulation vehicle speed information v, and the like at the time of start of simulation and outputs the vehicle speed control information to the vehicle simulation device 1.

The simple model computing portion 3 of the vehicle simulation device 1 corrects simulation relative distance information with respect to the preceding vehicle and simulation vehicle speed information of the vehicle of interest on the basis of the vehicle speed control information calculated by the ACC-ECU.

The ACC-ECU calculates new vehicle speed control information on the basis of the simulation information output from the simple model computing portion 3.

Thus, correcting the simulation information output to the ACC-ECU by the simple model computing portion 3 on the basis of the control information output from the ACC-ECU enables an examination as to the suitability of the feedback control of vehicle speed carried out by the ACC-ECU.

The broken lines shown in FIG. 7 represent vehicle-distance hunting properties resulting from feedback control of the vehicle speed carried out by the ACC-ECU with the simulation starting at time t.

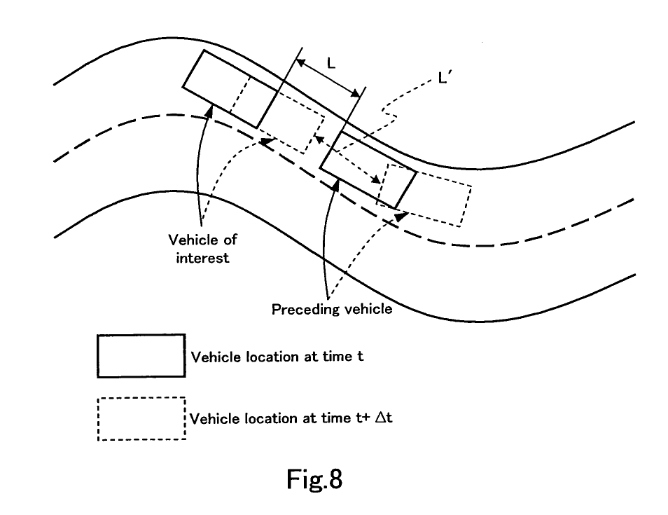

FIG. 8 shows the locations of the vehicle of interest and the preceding vehicle at time t of start of the simulation corresponding to FIG. 7 and after a lapse of time Δt. The solid lines represent states at the time of start of the simulation while the broken lines represent states after a lapse of time Δt. It can be seen that vehicle distance L is enlarged to vehicle distance L′ by the ACC-ECU.

That is, by outputting from the simple model computing portion 3 simulation information resulting from correcting the measured information, a change with time in the vehicle of interest, the preceding vehicle, the road state, and the like is simulated. This results in a dynamic examination of the effects of the improved logic of the ACC-ECU.

Also with the vehicle simulation device according to the present invention, when the simple model computing portion 3 carries out the simulation, the simulation information resulting from correcting the measured information is used to generate new measured information, which eliminates the need for much measured information to collect in advance. This is because the new measured information generated in the simulation is used in another simulation that follows, and the other simulation carried out on the basis of the new measured information involves a generation of other new measured information.

Also the vehicle simulation device according to the present invention easily deals with the case where there is a need for simulation using information that is difficult to measure from a real vehicle, examples including control information from a signal of the kind that is difficult to measure because the real vehicle mounts no sensors therein, and control information at the time of occurrence of an accident.

This is because the relative speed, relative distance, and the like at the time occurrence of an accident can be generated by correction if, for example, data about a relative speed, a relative distance, and the like before the accident are collected.

The modes of simulation carried out by the simple model computing portion 3 are preferably selectable on the basis of an instruction from the host computer 6.

The modes in which the simulation is carried out include one that outputs simulation information loyal to the original measured information, one that outputs simulation information corrected on the basis of the original measured information, and one that generates a new item of measured information in addition to outputting the simulation information corrected on the basis of the original measured information.

The memory of the host computer 6 manages measured information sampled from a real vehicle and measured information newly generated in the simulation. All or part of the information included in these pieces of measured information may be corrected or changed in advance, thereby securing various measured information.

Use of the above-described data collecting device and vehicle simulation device realizes a vehicle simulation method including: a measuring step of collecting, as measured information, a signal measured during an actual travel of a vehicle; a simulation step of generating simulation information by correcting the measured information collected in the measuring step on the basis of the measured information and control information output from an electronic control unit targeted for evaluation, and outputting the generated simulation information to the electronic control unit; and a recording step of recording a signal measured during the simulation step.

The vehicle simulation device 1 may include an evaluating portion for storing in the memory a result of a simulation in which the simple model computing portion 3 corrects the measured information and a result of a simulation in which the simple model computing portion 3 does not correct the measured information, and for comparably displaying the results on a display portion of the host computer 6.

Likewise, the vehicle simulation device 1 may include an evaluating portion for storing in the memory a result of a simulation in which the simple model computing portion 3 adds a new data item and a result of a simulation in which the simple model computing portion 3 adds no new data items, and for comparably displaying the results on a display portion of the host computer 6.

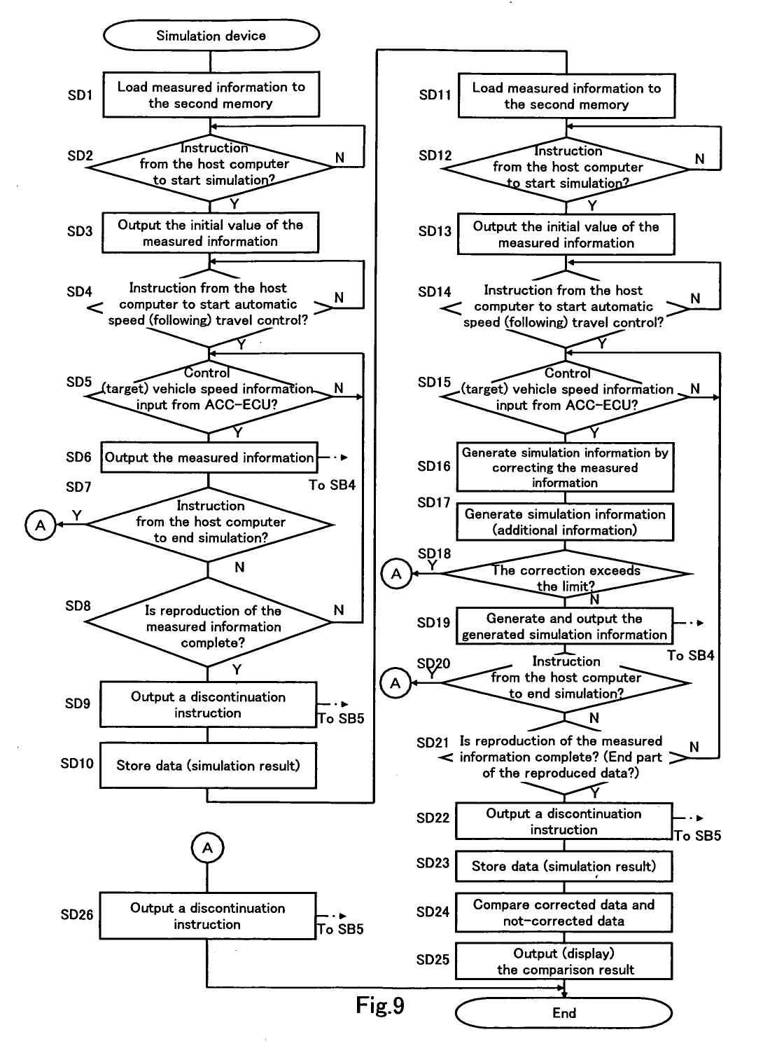

The operation of this vehicle simulation device 1 will be described by referring to the flowchart shown in FIG. 9.

The vehicle simulation device 1 carries out processing similar to steps SA1 to SA4 shown in FIG. 5 (SD1 to SD4). When the ACC-ECU inputs vehicle speed control information (SD5), the vehicle simulation device 1 transmits in return simulation information selected from measured information corresponding to the vehicle speed control information (SD6). That is, in step SD6, the simple model computing portion 3 does not correct the measured information and adds no new data items.

Upon ending of reproduction of the measured information for carrying out the simulation (SD8), the vehicle simulation device 1 outputs a discontinuation instruction to the ACC-ECU (SD9) and temporarily stores in the second memory 10c data input from the ACC-ECU as a simulation result (SD10).

Next, the vehicle simulation device 1 carries out processing similar to steps SA1 to SA9 shown in FIG. 5 (SD11 to SD19). That is, in steps SD11 to SD19, the simple model computing portion 3 corrects the measured information and adds a new data item.

Upon ending of reproduction of the measured information for carrying out the simulation (SD21), the vehicle simulation device 1 outputs a discontinuation instruction to the ACC-ECU (SD22) and temporarily stores in the second memory 10c data input from the ACC-ECU as a simulation result (SD23).

Then, the vehicle simulation device 1 compares the data stored in step SD 10 and the data stored in step SD23 (SD24) and outputs a result of the comparison to the host computer 6 to make the result displayed on the monitor 6a (SD25).

It is possible to output the data stored in step SD 10 and the data stored in step SD23 to the host computer 6 so that the host computer 6 compares these data and displays a result of the comparison on the monitor 6a.

When the host computer makes an end instruction during the simulation (SD7, SD20), the vehicle simulation device 1 outputs a discontinuation instruction to the ACC-ECU (SD26) and ends the simulation.

Making both results comparable in the above manner virtually realizes various operation states of the vehicle, thereby enabling quick simulations for examining the validity of respective operations.

While in the above-described embodiment description is made to the case where the ECU to be connected to the vehicle simulation device 1 is the ACC-ECU, any ECU may be connected. When an FEI-ECU is connected, the simple model computing portion 3 may include a simple engine model for outputting a simulation signal on the basis of measured information such as crank pulse information and cylinder pulse information of the engine, and even injection pulse information and ignition pulse information.

The simple engine model corrects and calculates the crank pulse information or cylinder pulse information included in the measured information on the basis of an injection pulse or an ignition pulse output from the FEI-ECU as control information, and outputs simulation crank pulse information or simulation cylinder pulse information to the FEI-ECU as simulation information.

For example, the simple engine model may include map data for regulating the width of correction of the simulation crank pulse or the simulation cylinder pulse corresponding to the simulation crank pulse information and a difference between a simulation ignition pulse period or a simulation injection pulse width and an ignition pulse period or an injection pulse width output from the FEI-ECU so that the simulation crank pulse information and the simulation cylinder pulse information are corrected on the basis of the map data.

When a radar ECU is connected to the vehicle simulation device 1, the simple model computing portion 3 may include a simple radar model computing portion 32 that has measured information including vehicle distance information and relative speed information with respect to the preceding vehicle and a beat signal occurring from the Doppler effect, and corrects a beat signal that occurs corresponding to a radar scanning signal output from the radar ECU on the basis of the radar scanning signal and the measured information.

The simple radar model computing portion 32 calculates relative speed information and relative distance information in the case of a change to vehicle speed information instructed from the host computer 6 on the basis of the vehicle speed information, the relative speed information, and the relative distance information included in the measured information, and corrects beat signals corresponding to these pieces of information.

In the case of an FMCW radar, which involves a wave multiplication phenomenon caused when the distance to the preceding vehicle becomes short and the radar wave is further reflected, it is possible to add to the simple radar model computing portion 32 a multiplied wave generating model computing portion for taking into consideration the multiplication phenomenon when the distance to the preceding vehicle becomes short.

The simple radar model computing portion 32 may also include a signal processing portion for reducing the level of the beat signal on the basis of braking information instructed from the host computer 6. This is for the purpose of simulating a reduction in the level of the reflected wave caused when the front of the vehicle is forced downward during braking and the radiation direction of the radar wave is displaced downward.

By arranging a model computing portion for generating simulation information indicating a vehicle state on the basis of measured information, the vehicle simulation device 1 according to the present invention may carry out an examination and the like of: an image identification logic for processing an image of the vehicle and its surroundings taken with a vehicle-mounted camera or the like; a control logic of a pre-crash control system (PCS) for carrying out vehicle crash prevention control and the like; and a control logic of a driver support system (DSS), which combines adaptive cruise control (ACC) and PCS and carries out wheel speed control for drift prevention, brake control for slippage prevention, and the like.

That is, the vehicle simulation device according to the present invention is characterized in including a simple model computing portion for generating simulation information by correcting measured information collected in advance in a time sequential manner on the basis of control information input from the electronic control unit.

The simple model computing portion is configured to output suitable simulation information resulting from correcting measured information on the basis of control information output from the electronic control unit such as feedback control information and learning control information. This enables an accurate examination of any control logics of the feedback control, the learning control, and the like carried out by the electronic control unit to the control target on the basis of the simulation information.

The above embodiments have been described by way of example only and it should be appreciated that the measured information and the simulation information can be set conveniently insofar as the simple model computing portion 3 constituting the vehicle simulation device 1 generates the simulation information by correcting the measured information on the basis of control information output from the electronic control unit and the measured information; the specific configurations of the measured information and the simulation information will not be limited to those in the above embodiment and any modifications are possible.

For example, in the case where the electronic control unit is an ACC-ECU, throttle openness information or information related to the brake operation may be employed as the control information output from the ACC-ECU, and information related to the vehicle speed, the vehicle distance, and the relative speed may be employed as the simulation information output from the simulation device.

In the case where the electronic control unit is an engine ECU, information related to the ignition pulse, the injection pulse, and throttle openness may be employed as the control information output from the engine ECU, and information related to the engine speed and the engine torque may be employed as the simulation information output from the simulation device.

In the case where the electronic control unit is an EPS-ECU, which controls the electronic power steering, information related to the steering assist torque may be employed as the control information output from the EPS-ECU, and information related to the steering torque may be employed as the simulation information output from the simulation device.

In the case where the electronic control unit is an LKA-ECU, which carries out lane keep assist control, information related to the steering assist torque may be employed as the control information output from the LKA-ECU, and information related to the degree of lane deviation may be employed as the simulation information output from the simulation device.

While description has been made to the vehicle simulation device, the simulation device according to the present invention is not only applicable to vehicles but to power plants and fluid system plants, in order to simulate, for example, the flow of water or air.

What is claimed is:

1. A simulation device connected to an electronic control unit targeted for evaluation in order to output thereto simulation information of a real vehicle in response to control information output from the electronic control unit, the simulation device comprising:
a measured information storing portion for storing measured information obtained from an actual travel of the real vehicle;
a simple model computing portion for generating simulation information by correcting the measured information on the basis of control information output from the electronic control unit; and
an outputting portion for outputting the simulation information generated by the simple model computing portion to the electronic control unit.

2. The simulation device according to claim 1, wherein the simple model computing portion generates the simulation information by correcting measured information that is measured control information included in the measured information and corresponds to the simulation information on the basis of control information output from the electronic control unit.

3. The simulation device according to claim 1, wherein:
the measured information includes: road profile information obtained from a travel of the real vehicle; and relative speed information and relative distance information obtained from vehicle speed information of the real vehicle corresponding to the road profile information with respect to another vehicle; and
the simple model computing portion outputs, as the simulation information, the relative speed information and relative distance information obtained from the vehicle speed information of the real vehicle with respect to the other vehicle after correcting the measured information on the basis of the control information output from the electronic control unit.

4. The simulation device according to claim 1, wherein:
the simple model computing portion calculates a difference between the measured information and the simulation information generated by correcting the measured information; and
when the difference deviates from a predetermined range, the simple model computing portion ends the simulation.

5. The simulation device according to claim 1, wherein the simple model computing portion calculates a difference between the control information output from the electronic control unit and measured control information included in the measured information and corresponding to the control information, and generates the simulation information by correcting the measured information on the basis of the difference.

6. The simulation device according to claim 1, wherein:
the measured information includes vehicle state information indicating a state of the real vehicle and environment state information indicating an environment in which the real vehicle travels;
the simple model computing portion calculates a difference between the control information output from the electronic control unit and measured control information included in the measured information and corresponding to the control information, and corrects the vehicle state information on the basis of the difference;
the simple model computing portion calculates a difference between the corrected vehicle state information and measured vehicle state information included in the measured information and corresponding to the vehicle state information, and corrects the environment state information on the basis of the difference; and
the simple model computing portion renders the corrected vehicle state information and the corrected environment state information the simulation information.

7. A simulation method comprising:
a measuring step of collecting, as measured information, a signal measured during an actual travel of a vehicle;
a simulation step of generating simulation information by correcting the measured information collected in the measuring step on the basis of the measured information and control information output from an electronic control unit targeted for evaluation, and outputting the generated simulation information to the electronic control unit; and
a recording step of recording a signal measured during the simulation step.
